(19) United States
(12) Patent Application Publication
(10) Pub. No.: US 2024/0409043 A1
(43) Pub. Date: Dec. 12, 2024

(54) TRIM ELEMENT COMPRISING A DETECTION DEVICE

(71) Applicant: AGC GLASS EUROPE, Louvain-la-Neuve (BE)

(72) Inventors: Jean MASSON, Gosselies (BE); Robert HICK, Chênée (BE); Sébastien DELNEUFCOURT, Gosselies (BE); Bert PHILIPS, Gosselies (BE)

(73) Assignee: AGC GLASS EUROPE, Louvain-la-Neuve (BE)

(21) Appl. No.: 18/706,619

(22) PCT Filed: Dec. 2, 2022
(86) PCT No.: PCT/EP2022/084299

§ 371 Date: May 1, 2024

(30) Foreign Application Priority Data
Dec. 3, 2021 (EP) 21212381.4

(51) Int. Cl. B60R 13/04; B29C 45/14; B29L 31/30; G01S 7/481; G01S 17/89; G01S 17/931

(52) U.S. Cl. CPC B60R 13/04; B29C 45/14434; G01S 7/4813; G01S 17/89; G01S 17/931; B29L 2031/3041

(57) ABSTRACT

A trim element for a vehicle including an aperture, a detection device operating with waves within a determined wavelength range and containing a sensing device, a protective housing enclosing said detection device and a cover lens made of at least one glass sheet having an absorption coefficient lower than 5 m⁻¹ in a wavelength range from 750 to 1650 nm. The cover lens is fixed to the protective housing. The detection device is placed facing the aperture. The cover lens facing the aperture is surrounded by the trim element, and the cover lens is fixed to the trim element with a soft material having a hardness of 50 to 90 Shore A.

### FIELD OF THE INVENTION

The invention relates to a vehicle's trim element comprising a detection device operating with waves within a determined wavelength range comprising a sensing device detection device operating with waves within a determined wavelength range comprising a sensing device, a cover and a protective housing enclosing said sensing device.

More particularly, the present invention relates to a lidar (light detection and ranging) as sensing device.

The invention related also to a method for fixing a detection device to a vehicle's trim element.

### BACKGROUND OF THE INVENTION

Today, the tendency is to use autonomous vehicles. An autonomous vehicle, also called driverless vehicle, self-driving vehicle or robotic vehicle, is a vehicle able to analyze its environment by itself in order to navigate without human input. An automotive vehicle includes cars, vans, lorries, motorbikes, buses, trams, trains, airplanes, helicopters and the like.

An autonomous vehicle detects its surroundings using various sensing devices such as radar, lidar, camera, sonar. Information received through the sensing devices are then processed to determine the navigation path of the vehicle, allowing the vehicle to navigate without collision with both fixed and moving objects of its environment.

ADAS (Advanced Driver Assistance System) also needs detection techniques to assist the driver based on the surroundings of the vehicle.

Among all detection techniques, lidar is a very useful one to offer 3D images with good resolution. Lidar is a technology that measures distance to a target by illuminating the target with laser light and measuring the reflected light with a sensor. Differences in laser return times and wavelengths can then be used to make digital 3D representations of the target. Lidar is also called 3D laser scanning. There exists several types of lidars: scanning, rotating, flashing or solid state lidars. While scanning and rotating lidars use continuous laser, flashing and solid state lidars use laser pulses.

The sensing devices can be integrated to a vehicle as a stand-alone device. It is then enclosed by a protective housing comprising a cover. They can also be integrated behind existing covers, such as windshield, backlite, sidelite, on bumpers, applique, front and rear-end module, front and rear fenders, roof. They can also be integrated behind trim elements and more particularly behind an external trim element. A trim element for automotive refers to an item that can be added to the interior or the exterior of a vehicle to increase its appeal or to mask some unaesthetic parts of the vehicle.

Depending on the type of integration, the cover can be made of glass, plastic and/or other materials, as long as it is transparent to the operating wavelength range of the sensing device. It can have many shapes. It can be flat or bent.

The detection device and more particularly a LiDAR sensing device may be placed in different placed in and/or a car and more generally any transportation vehicle as car, plane, . . . . Indeed, the LiDAR system is known to be placed behind a windshield, as described in the published patent application WO2018015312 but also as an external trim element as in WO WO2018015313, on bumper, fender. It is also well known to place a LiDAR on the roof of a car.

The localization of the sensing devices is critical to operate at their best. They need to be located where that can have the largest and most effective overview of the target to be measured. For that reason, LiDAR sensing devices are preferably placed on the roof, or applique or also bumper or fenders. Most preferably, the detection device and more particularly a Lidar as detection device is fixed to the roof to have the greater field of view. However, when a detection device and more particularly a LiDAR is fixed to the roof, the external aspect of the detection device is not aesthetic and it is not fixed properly to combine good aesthetic and good and safe fixation of the sensing device to the trim element.

Today, classically, the glass cover, and more generally the sensing device, may be fixed to the trim element of the detection device by encapsulation. The assembly should then be fixed to the aesthetic plastic to support the detection device and more particularly a Lidar.

Furthermore, the assembly should be placed on the roof close to the upper edge of the windshield.

However, the encapsulation in that case leads to some issues as:
high pressure is put on the glass to the encapsulation process leading to deterioration of the glass,
if the glass cover is coated, there is a risk of damaging of the coating.
Thus, there is a need of a trim element with a cover lens to protect the detection device and more particularly a LiDAR sensing devices, that provide a good aesthetic and safe with a cover well and properly fixed to the trim element.

### DESCRIPTION

The present invention proposes a trim element (1) for vehicle comprising:
a. an aperture (2) wherein a detection device (3) is placed facing the aperture (2),
b. a detection device (3) operating with waves within a determined wavelength range and comprising a sensing device,
c. a protective housing enclosing said detection device,
d. a cover lens (4), made of at least one glass sheet having an absorption coefficient lower than 5 m-1 in the wavelength range from 750 to 1650 nm, the said cover lens being fixed to the protective housing.

Thus, according to the invention, the glass sheet has an absorption coefficient lower than 5 m-1 in the wavelength range from 750 to 1650 nm. To quantify the low absorption of the glass sheet in the infrared range, in the present description, the absorption coefficient is used in the wavelength range from 750 to 1650 nm. The absorption coefficient is defined by the ratio between the absorbance and the optical path length traversed by electromagnetic radiation in a given environment. It is expressed in m⁻¹. It is therefore independent of the thickness of the material but it is function of the wavelength of the absorbed radiation and the chemical nature of the material.

In the case of glass, the absorption coefficient (μ) at a chosen wavelength λ can be calculated from a measurement in transmission (T) as well as the refractive index n of the material (thick=thickness), the values of n, ρ and T being a function of the chosen wavelength λ:

$$μ = - \frac{1}{thick} \cdot ln [ \frac{- {( 1 - ρ )}^{2} + \sqrt{{( 1 - ρ )}^{4} + 4 \cdot {T}^{2} \cdot {ρ}^{2}}}{2 \cdot T \cdot {ρ}^{2}} ]$$

with ρ=(n−1)²/(n+1)².

The glass sheet according to the invention preferably has an absorption coefficient in the wavelength range of 750-1650 nm, generally used in optical technologies relating to the invention, very low compared to conventional glasses. In particular, the glass sheet according to the invention has an absorption coefficient in the wavelength range from 750 to 1650 nm lower than 5 m⁻¹.

According to a preferred embodiment of the present invention, the glass sheet has an absorption coefficient in the wavelength range of 750 to 1000 nm lower than 5 m⁻¹.

A low absorption presents an additional advantage that the final IR transmission is less impacted by the optical path in the material. It means that for large field of view (FOV) sensors with high aperture angles the intensity perceived at the various angles (in different areas are the image) will be more uniform, especially when the sensor is optically coupled to the glazing.

According to the present invention, the cover lens, facing the aperture is surrounded by the trim element and the cover lens is fixed to the trim element with a soft material with a hardness of 50 to 90 Shore A.

Thanks to the proposed invention, the issues related to difference of dilatation between the glass cover lens and the trim element on which the cover lens is fixed, are reduced. Also, the issues disclosed above are also reduced even avoided.

According to one embodiment of the present invention, the cover lens is fixed to the trim element with as soft material a material chosen amongst thermoplastic elastomers (TPE) or thermosets material such as Polyurethane (PUR), Epoxies (EP), PVC, with a hardness of about 50 to 90 Shore A.

The cover lens is then fixed to the trim element through the edges the periphery of the cover lens. This kind of soft material has soft elastic properties, offering a perfect fit to the parts of the vehicle body, vibration and noise damping and a sealing effect.

According to an embodiment of the present invention, the cover lens is bound to the trim element with a poured soft material with a hardness of about 50 to 90 Shore A.

According to an embodiment of the present invention, the soft material is a material chosen amongst thermoplastic elastomers (TPE) or thermosets material such as Polyurethane (PUR), Epoxies (EP), PVC, with a hardness of about 50 to 90 Shore A that is sprayed (poured, casted) between the peripheral contour of the cover lens and the edges of trim element in a mould. Thus, the cover lens may be flush with the peripheral edges of aperture provided in the trim element with no gap between the cover lens and the trim element. Thus, besides the aesthetical aspect, the sensing device and more particularly the LiDAR is better protected against air, dust and water. One of advantage of this technology is that the cover lens is well and quickly fixed to the trim element.

Furthermore, by casting the soft material, the difference of dilatation between the glass cover lens and the trim element on which the cover lens is fixed, will lead to less risk of breakage of the glass cover lens, due to the presence of this soft element. Also, less pressure is applied on the glass cover lens.

Thus, it is proposed to fix the cover to the aesthetic piece by pouring or casting (or spraying) a soft material according to the invention. The technology is based on a quick gluing by injecting two components that reticulate when being in contact. The process used allows to reduce the cost pf production. The process to fix the cover lens to the trim element is also simplified.

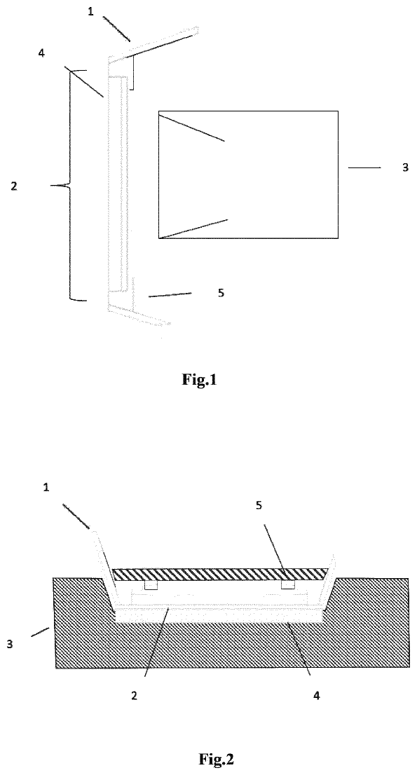

The FIG. 1 shows, according to one embodiment of the present invention a trim element (1) for vehicle comprising:
a. an aperture (2) wherein a detection device (3) is placed facing the aperture (2),
b. a detection device (3) operating with waves within a determined wavelength range and comprising a sensing device,
c. a protective housing (7) enclosing said detection device,
d. a cover lens (4), made of at least one glass sheet having an absorption coefficient lower than 5 m⁻¹ in the wavelength range from 750 to 1650 nm, the said cover lens being fixed to the protective housing.

According to the present invention, the cover lens (4), facing the aperture (2) is surrounded by the trim element (1) and the cover lens (4) is fixed to the trim element (1) with a soft material (5) with a hardness of 50 to 90 Shore A.

As shown in FIG. 2 according to one embodiment of the present invention, during the assembly process of the trim element (1) with the cover lens (4), the trim element (1) is placed into a nest (6) with the cover lens (2). A soft sealing material (5) in a range from 30 to 90 shore A is used into the nest (6) in order to ensure the flushness between the trim element and the lens cover (4) and the sealing between the cover lens (2), the trim (1) and the nest (6) during the pouring process. Parts are fixed into the nest (6) by using clamps made of at least a soft sealing component (5) with a shore A in a range from 30 to 90 in order to decrease the pressure on the element and therefore decrease significantly the risk of damage of the trim element and the cover lens. The cover lens to be used may be then provided with some functionalities as coating or laminated cover lens may be used

By using a soft material according to the present invention, the process of fixation of the cover lens to the trim element is simplified. Furthermore, a flush design between the cover lens with the peripheral edges of aperture provided in the trim element.

According to another embodiment of the present invention, the cover lens is bound to the trim element with a poured polyurethane soft material with a hardness of about 50 to 90 Shore A. The poured polyurethane soft material is for example a mix comprising polyol, isocyanate and catalysts. The mix can then be poured between the cover lens and the trim element to fix the cover lens to the trim element into a mold with no additional pressure. The advantage of this technology of fixation is that the time of reticulation is quick. Thus, the cover is quickly fixed to the trim avoiding any undesirable movement of the cover lens.

According to one embodiment of the present invention, the trim element is made of an assembly of a support part to be fixed to the vehicle body and an aesthetic part provided on the support part. The assembly is for example advantageous in the case the trim element is a roof trim element to support a sensing device such as Lidar.

The aesthetic part also called the skin may be a part painted to fit with the vehicle's aesthetic or to answer the requirement in term of color of the buyer of the vehicle. It may be assembled with a «technical» support part on which the various fasteners are placed. Contrary to the classical encapsulation where the trim provided with at least the glass cover lens, should be placed into a mold that is to closed on this assembly with the risk of scratching the aesthetic part (skin) or even breaking it.

According to an embodiment of the present invention, the aesthetic part is made of plastic material.

According to the present invention, the trim element is a vehicle's trim element. It is understood that a vehicle is a transportation vehicle like a car, train, a truck, a plane . . .

According to an embodiment of the present invention, the trim element is fastened to the vehicle or car body through the support part. In case the trim element comprises an esthetic part and a support part, the support part is preferably fastened to the vehicle or car body.

According to the present invention, the cover lens may be permanently fixed to the protective housing by for example gluing or fixed in a way that the cover lens may be removed easily and exchanged in the event of breakage and not all the detection device, thus reducing the cost of reparation/replacement.

According to one embodiment of the present invention, the trim element is a vehicle's roof trim element. The trim element may be placed on the roof of a vehicle and more particularly a car. More particularly, the trim element is placed in the vicinity of the upper part of the windshield in the vicinity of the roof of the vehicle and more particularly the car. The detection device placed on the roof has therefore a better field of view. For safety and aesthetic reasons, the trim element advantageously comprises an aesthetic part and a support part, the support part is preferably fastened to the vehicle or car body. The aperture behind which the detection device is placed is then provided in the aesthetic part. The support is then fastened to the roof to allow a good and safe fixation of assembly comprising the trim element and the detecting device.

According to another embodiment of the present invention, the trim element with a detecting device is positioned on a vehicle for example on bumpers, applique, front and rear end module, front and rear fenders, roof, windshield. For additional safety, the vehicle could be equipped with several detecting devices all around the vehicle.

According to an embodiment of the present invention, the detecting device is a scanning, rotating, flashing or solid state LiDAR device enabling of 3D mapping, and emitting a laser beam of wavelength ranging between 750 and 1650 nm.

The present invention concerns also a process to manufacture a trim element according to the present invention comprising the following steps as shown in FIG. 2:
a. Sitting the trim element (1) having an aperture (2) to accommodate the cover lens (4) of the detecting device (1) into a nest (6),
b. Centering the cover lens (4) into the aperture (2) of the trim element (1),
c. Closing the ring frame on the trim element and the cover lens (4) in order to create the sealer gasket cavity,
d. Filling the gap surrounding the periphery of the cover lens (4) and the aperture (2) of the trim element (1) by casting or injecting a material made of soft material (5) with a hardness between 50 to 90 Shore A.

The cover lens (4) is then fixed to trim element (1) thanks to the soft material (5) with a hardness of 50 to 90 Shore A.

The soft material (5) according to the present invention reticulates quickly to strongly bond the cover lens to the aperture provided into the trim element (1) The soft material may be poured or injected into the cavity of a mold. Thanks to the present invention, the cover lens (4) may be flush with the trim element (4) providing a good aesthetic to the trim element (4).

According to one embodiment of the present invention, when the trim (1) is an assembly of an aesthetic part and a support part, then the aesthetic part is provided with aperture to accommodate the cover lens (4) of the detecting. The aesthetic may be placed alone or with the support part inside the cavity of a mold. Then the gap between the aesthetic part and the cover lens (4) is filled with a soft material with a hardness of 50 to 90 Shore A.

According to an embodiment of the present invention, the cover lens is made of at least one glass sheet having an absorption coefficient lower than 5 m⁻¹ in the wavelength range from 750 to 1650 nm, the said cover lens.

According to an embodiment of the present invention, the soft material is a made of polyurethane. Thus, the polyurethane framing and bonding and sealing of the cover lens may be made in one operation and in cos-efficient way.

The polyurethane frame is cast on the product in a completely open mold. This pressure-free and stress-free casting process uses a flexible mold or “soft tool” which makes it possible to provide products with large form tolerances with a close-fitting seal. In technical terms, this is called flushing glazing.

The synchronous robotized movements of the dosing head and of the mold ensure that the polyurethane is applied in the perfect and desired shape.

The process according to the present invention, offers high flexibility in terms of product dimensions and a not unimportant additional advantage are the budget-friendly molds. The possibility of performing both framing and gluing with identical polyurethane material during the same process also makes it a cost-efficient technology. Furthermore, the drying times shorter than 60 seconds thanks to reactive polyurethane system.

The process according to the present invention allows a pressure-free polyurethane casting process with a dynamic mixing under low pressure, accurate dosing volume, wide range of options for casting flow. Furthermore, the “soft tool” technology allows no glass breakage, allows to work with thin and lightweight glass, a perfect polyurethane surface/flush glazing and texturization options.

1. A trim element for a vehicle comprising:
an aperture;
a detection device operating with waves within a determined wavelength range and comprising a sensing device;
a protective housing enclosing said detection device; and
a cover lens made of at least one glass sheet having an absorption coefficient lower than 5 m⁻¹ in a wavelength range from 750 to 1650 nm,
wherein the cover lens is fixed to the protective housing,
wherein the detection device is placed facing the aperture,
wherein the cover lens facing the aperture is surrounded by the trim element, and
wherein the cover lens is fixed to the trim element with a soft material having a hardness of 50 to 90 Shore A.

2. The trim element according to claim 1, wherein the soft material is a thermoplastic elastomer (TPE) or a thermoset material.

3. The trim element according to claim 1, wherein the detection device is an optical sensing device.

4. The trim element according to claim 1, wherein the cover lens is fixed to the trim element with a poured soft material.

5. The trim element according to claim 1, wherein the cover lens is fixed to the trim element with a poured polyurethane soft material.

6. The trim element according to claim 1, wherein said trim element is made of an assembly of a support part to be fixed to a body of the vehicle and an aesthetic part provided on the support part.

7. The trim element according to claim 6, wherein said aesthetic part is made of a plastic material.

8. The trim element according to claim 1, wherein said cover lens is flush with peripheral edges of the aperture provided in the trim element.

9. The trim element according to claim 6, wherein said trim element is fastened to the vehicle through the support part.

10. The trim element according to claim 1, wherein said cover lens is not permanently fixed to the protective housing.

11. The trim element according to claim 1, wherein said trim element is a vehicle's roof trim element.

12. The trim element according to claim 11, wherein the detection device is fixed on the roof of the vehicle in a vicinity of an upper edge of a windshield.

13. The trim element according to claim 1, wherein the trim element is positioned on bumpers, applique, front and rear end modules, front and rear fenders, or a windshield of the vehicle.

14. The trim element according to claim 1, wherein the detection device is a LIDAR sensing device,
wherein the LIDAR sensing device is a scanning, rotating, flashing or solid state LIDAR device enabling of 3D mapping, and emitting a laser beam of wavelength ranging between 750 and 1650 nm.

15. A method for manufacturing the trim element according to claim 1, comprising:
sitting the trim element having an aperture to accommodate the cover lens of the detecting device into a nest,
centering the cover lens into the aperture of the trim element,
closing a ring frame on the trim element and the cover lens in order to create a sealer gasket cavity, and
filling a gap surrounding a periphery of the cover lens and the aperture of the trim element by spraying or injecting the soft material having a hardness between 50 to 90 Shore A.

16. The method according to claim 15, wherein the trim element is an assembly of an aesthetic part and a support part, the aesthetic part being provided with the aperture to accommodate the cover lens of the detection device.

17. The method according to claim 15, wherein the spraying or injecting is made for outside or inside a molding tool.

18. The method according to claim 16, wherein the assembly is fixed to a vehicle's body through the support part and then the detection device and the protective housing are fixed to the trim element.

19. A vehicle comprising the trim element according to claim 1.
